(19) United States
(12) Patent Application Publication
(10) Pub. No.: US 2006/0064212 A1
(43) Pub. Date: Mar. 23, 2006

(54) Reactive automated guided vehicle vision guidance system

(75) Inventor: Henry F. Thorne, Pittsburgh, PA (US)

Correspondence Address: BLYNN L. SHIDELER;THE BLK LAW GROUP, 3500 BROKKTREE ROAD, SUITE 200, WEXFORD, PA, 15090, US

(73) Assignee: Cycle Time Corporation, Pittsburgh, PA (US)

(21) Appl. No.: 11/233,526

(22) Filed: Sep. 22, 2005

Related U.S. Application Data
(60) Provisional application No. 60/611,953, filed on Sep. 22, 2004.

(51) Int. Cl. G01C 22/00

(52) U.S. Cl. 701/23; 701/25; 180/167

(57) ABSTRACT

A reactive AGV system includes an AGV vision guidance system which places the camera system and controlled lighting sources between the drive wheels of the AGV to shield from ambient light and provide a constant lighting condition. The AGV guide path includes physical path properties for controlling AGV behavior. Visual Parameters of the guide path such as line thickness, line color, the presence and form of a secondary control line, or the presence of distinct a line elements may all be used as visual input control signals for the AGV. Additionally viewable icons are used for controlling AGV routing. These icons may, preferably, also be human readable to enhance the customer understanding and therefore usage of the system.

### RELATED APPLICATION

The present application claims the benefit of provisional patent application Ser. No. 60/611,953 filed Sep. 22, 2005 and entitled “Reactive Automated Guided Vehicle Vision Guidance System”.

### BACKGROUND INFORMATION

1. Field of the Invention

The present invention relates to vision systems for Automated Guided Vehicles (AGVs), and more particularly to vision system placement of a reactive AGV and communicating control signals to the reactive AGV and to those around the AGV.

2. Prior Art

Automatic Guided Vehicles have been used to transport materials for many years. One method for guiding these vehicles is to utilize complex robotic vehicle positioning systems such position locating tags/beacons, or other sensors, or even GPS systems (which is of limited use in indoor environments) together with the knowledge of a world map in the robotic vehicle. These systems are complex to develop and to implement. Another system has been the placement of a physical line on the floor along the desired path of the vehicle. A tracking system is placed in the vehicle which servos off of this line to maintain the vehicle's travel along the line. The tracking systems have generally been composed of a linear array placed perpendicular to the line which provides some feedback pertaining the distance the vehicles is offset from the line. This track following system is considered, within the meaning of this application, as a purely “reactive” AGV system in that the AGV merely reacts to the indicated path (e.g. follows a curve to the right, a curve to the left or goes straight). The path reactive AGV is contrasted with the robotic type AGVs that utilize a world map. These may be considered as planned AGV systems in that the intended path from a starting point to a destination is pre-planned by the AGV based upon the world map knowledge (as opposed to pre-planned by the system implementation due to a track location).

With the advance of vision based technology and its use bringing down its cost, vision based systems have been proposed in recent years, see U.S. Pat. No. 6,493,614 granted Dec. 10, 2002 incorporated herein by reference. These systems provide richer feedback than linear arrays which can be used to enhance the guidance of the vehicle including not only the displacement of the linear array systems but also curvature and feed forward control information based on path that has not yet been reached by the vehicle.

There remains a need in the industry for a low cost, easily implemented AGV system that minimizes initial installation costs and concerns as well as post installation modifications. There is a further need for AGV systems that are readily accepted by those in the work environment.

### SUMMARY OF THE INVENTION

The above objects are achieved with the reactive AGV vision guidance system according to the present invention. The present invention includes an AGV vision guidance system that places the camera system and controlled lighting sources between the drive wheels of the AGV to shield from ambient light and provide a constant lighting condition. The AGV guide path includes physical path properties for controlling AGV behavior. Visual Parameters of the guide path such as line thickness, line color, the presence and form of a secondary control line, or the presence of distinct line elements may all be used as visual input control signals for the AGV. Additionally viewable icons are used for controlling AGV routing. These icons may, preferably, also be human readable to enhance the customer understanding and therefore usage of the system. The system according to the present invention provides a purely reactive low cost, easily implemented AGV system minimizing initial installation costs and concerns as well as making post installation modifications essential trivial. Further the reactive AGV system according to the present invention more easily communicates its operation to those in its working environment and is therefore more readily accepted by those in its work environment.

### BRIEF DESCRIPTION OF THE DRAWINGS

FIG. 1 is a schematic plan view of an AGV vision guidance system according to one aspect of the present invention;

FIG. 2 is a schematic elevation side view of the AGV vision guidance system of FIG. 1;

FIG. 3 is a schematic plan view of one representative example of an AGV guide path including physical path properties for controlling AGV behavior according to the present invention;

FIG. 4 is a schematic plan view of another representative example of an AGV guide path including physical path properties for controlling AGV behavior according to the present invention;

FIG. 5 is a schematic plan view of another representative example of an AGV guide path including physical path properties for controlling AGV behavior according to the present invention;

FIG. 6 is a schematic plan view of another representative example of an AGV guide path including physical path properties for controlling AGV behavior according to the present invention;

FIG. 7 is a schematic plan view of another representative example of an AGV guide path including physical path properties for controlling AGV behavior according to the present invention;

FIG. 8 is a schematic plan view of another representative example of an AGV guide path including physical path properties for controlling AGV behavior according to the present invention;

FIG. 9 is a schematic plan view of a representative example of an AGV viewable icon for controlling AGV behavior according to the present invention;

FIG. 10 is a schematic plan view of another representative example of an AGV viewable icon for controlling AGV behavior according to the present invention;

FIG. 11 is a schematic plan view of another representative example of an AGV viewable icon for controlling AGV behavior according to the present invention;

FIG. 12 is a schematic plan view of another representative example of an AGV viewable icon for controlling AGV behavior according to the present invention;

FIG. 13 is a schematic plan view of another representative example of an AGV viewable icon for controlling AGV behavior according to the present invention;

FIG. 14 is a schematic plan view of another representative example of an AGV viewable icon for controlling AGV behavior according to the present invention;

FIG. 15 is a schematic plan view of a representative example of an AGV guide path for one floor for the reactive AGV system according to the present invention with modifications to the guide path shown in phantom; and

FIG. 16 is a perspective view of an AGV using a vision guidance system according to the present invention.

### BRIEF DESCRIPTION OF THE PREFERRED EMBODIMENTS

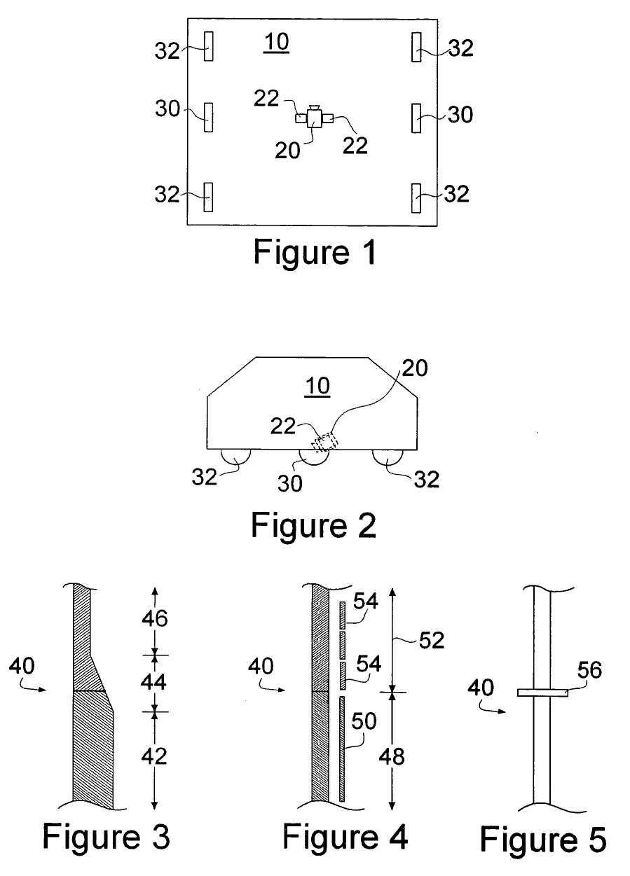

FIGS. 1 and 2 schematically illustrate an AGV vision guidance system according to one aspect of the present invention. As discussed above, existing vision based guidance systems for AGVs are vulnerable to error from changing ambient or reflected light especially from changing sun conditions in windowed corridors. The AGV vision guidance system of the present invention minimizes this weakness through the placement of the vision system relative to the robot body 10. Specifically, as shown in the FIGS. 1 and 2 the camera system 20 is placed between the drive wheels 30 of the AGV. There is no limitation on where the drive wheels 30 of a given AGV are located. Some are centrally mounted (as shown in the figures), and may include further wheels 32 in front or behind (with either wheels 30 or 32 being steered). The AGV may have the drive wheels 30 in the back of the vehicle with a pair, or a single central wheel 32 in the front. The AGV may further have the drive wheels 32 in the front of the chassis with a pair or a single drag wheel 32 behind. There are numerous known arrangements for the drive wheels 30 and other wheels 32 which are determined largely through the intended use of the AGV.

The key feature of the camera system 20 placement according to the present invention is that this area generally central on the robot body 10 between the drive wheels 30 can be shielded from ambient light while being lit by a controlled lighting source 22. The use of the controlled light source 22, together with the effective shielding of the vehicle body, will eliminate any effect of variance in ambient light. In other words, with the controlled light source 22 and the shielded environment the camera system 20 will view the guide path 40 the same with no ambient light (e.g. night) as with high levels of ambient light (e.g. sunny daytime with significant window glare). The controlled light source will provide a consistent path viewing condition for the camera system 20. Any conventional light source can form the light source 22, although LED or other solid state light source may minimize heating issues associated with light sources. The positioning of the camera system 20 between the drive wheels 30 allows these advantages to be obtained without consuming an expanded footprint that would be required to shield the vision input from ambient light if the camera or vision system 20 were mounted outside of the AGV. In addition the steering control of the AGV, which is typically done by counter-rotation of the drive wheels 30, is centered directly on the control feedback source (which is the camera system 20). This central positioning of the feedback control source (i.e. the camera system 20) enhances the stability of the vehicle control.

The mounting of the camera system 20 centrally between the drive wheels 30 will not pose a significant issue in most commercial applications. Consequently the present system is well suited for retrofitting onto many existing AGVs. Further, the present system will further minimize the profile of such existing AGVs by removing the external camera vision systems that are protruding therefrom (generally off of the front of the AGV).

The vision system for the AGV according to the present invention is designed to source its own lighting and protect from outside lighting interference as noted and it provides an excellent steering capability for the AGV. Notably it can steer the vision system in a place which will be particularly useful when searching for the line 40 after a manual restart.

Another feature of this system is that it's completely reactive. The AGV receives all routing instructions from the path and associated viewed icons, as will described in further detail below. The system can be restarted from power-down anywhere anytime because it needs no prior knowledge or high level knowledge that could be lost in a power down (e.g. such as a known position and orientation in a known world map). All an AGV “knows” is its home and its destination (each of which can be easily set through a simple input device such as a thumb wheels) and all it does is travel seeking one of those two destinations following the instructions on the line 40 as noted below.

FIGS. 3-9 schematically illustrate various representative examples of an AGV guide path 40 including physical path properties for controlling AGV behavior according to another key aspect of the present invention. This development more fully utilizes the richer information provided by the vision based solution for AGV line tracking. In general, this aspect of the invention uses the physical properties that are part of the line or path 40 to control the behavior of the AGV (apart from the direction of the path). For example as shown in FIG. 3 line thickness of the path 40 can control one parameter of the AGV such as the intended speed of the vehicle. FIG. 3 then illustrates a path 40 for the AGV in which the speed of the AGV is at one level in section 42 of the path, decreases through section 44 of the path 40, and reaches a second level at section 46 of the path 40. Further, line color (as represented by distinct hatching in FIGS. 3 and 4) of the path 40 can provide a further dimension of input (i.e. a separate control signal) to the vehicle. Line color could be used, for example, to dictate the volume control or loudness of the AGV sound systems (e.g. its warning systems). Therefore, in FIG. 3 the volume of the AGV will change as it moves from section 42 to 46 of the path 40 (or visa-versa). The control signals for the vehicle are not intended to be limited to speed and volume for the AGV, since effectively any property or function of the AGV can be controlled with these inputs, as desired in the particular application.

Further, other line property variations may be used as vehicle input control signals for the vision system. FIG. 4 illustrates the use of secondary control line along the path 40 in which, for example, in section 48 of the path 40 a solid line may instruct the AGV stay in the lane on the path and not pass obstructions detected (i.e. a no passing zone). Section 52 of path 40 has a dashed line 52 that may instruct the vehicle that passing obstructions is permitted (e.g. passing lane). This example is of course analogous to the line instructions for cars on roadways. Again these proposed control inputs can be used for controlling any variable function of the AGV. Further they can be used in any combination, such as shown where the color of the path 40 changes between section 48 and section 52 of the path 40 to provide another control input (e.g. sound control). This system is particularly appropriate for controlling AGVs which navigate through multiple environments including some public and other non-public corridors such as hospitals.

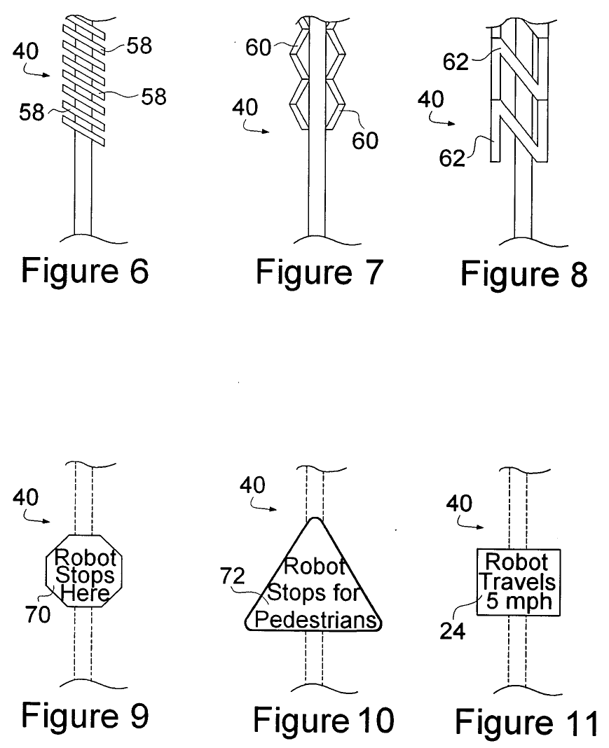

As further representative examples of the line properties or icons being used as control signals to the AGV, FIG. 5 as a line element 56 along path 40 that may indicate a location for the robot to drop of a carried load; FIG. 6 has a line element 58 along path 40 that may instruct the AGV to take a reading (e.g. air quality control, temperature, etc); FIG. 7 has a line element 60 along path 40 that may instruct the AGV to check security parameters (e.g. a watch or check point for a security AGV); and FIG. 8 has a line element 62 along path 40 that may instruct the AGV that it is passing though or at a nurses station and to perform the functions that have been designated for it at such location. FIG. 5 is iconic as opposed to continuous line properties shown in FIGS. 3-4. Both aspects of the path properties can be used with almost infinite variations on the examples of possible control signals under this system.

One inexpensive implementation of the system can be through formation of the line 40 with the reflective and track the reflective tape formed line 40 with just three sensors looking down at the tape. The middle sensor should see strong signal, other two sensors detect deviations from the line and are used for correcting. The line 40 can be broken in Morse code fashion (instead of solid line) to convey operating signals to the onboard controller (uC) of the AGV. The PC and Camera system 20 are not even needed for this inexpensive implementation. An uC could be used which can easily filter the Morse code instructions. Further, a detector every half inch across the 4″ gap between the wheels 30 would even be able to solve the “get back on path” problem. Line width could be detected for speed control, as could passing lane dashes. Finally, Morse code could be replaced with bar code easily enough. Although not human readable, the code could be placed on the line and a sign next to it for the humans to understand.

FIGS. 9-14 schematically further illustrate representative examples of AGV viewable icons for controlling AGV behavior according to the present invention. Viewable icons along the AGV path 40 may be used for controlling all aspects of AGV routing. These icons can be used to form complete routing systems to guide the AGVs to multiple customer selectable destinations, and perform selected operations at desired locations or change AGV behavior along selected portions. These icons may, preferably, also be human readable to enhance the customer understanding and therefore usage of the system. These icons could also combine human readable and a machine readable form (e.g. a barcode). The icons describe to the AGV control system the actions that are to be taken including stopping, yielding, forking, door opening, and elevator control. The human readable versions will also convey the anticipated AGV behavior to those around the AGV. This can be very helpful for public acceptance of the vehicles where they are utilized in a public arena, such as a hospital. In the preferred embodiment the vision system used for guidance is the same one that is used for icon recognition.

For example in FIG. 9 the icon 70 is in the form of a stop sign indicating to the vehicle and to those around the vehicle that it is intended to stop at this location, for some period of time. The stop may be a location to await an elevator, or to deliver or pickup, or just a terminal rest location for the vehicle. The path 40 is shown in phantom, since it is contemplated that this aspect of the present invention could be used with visible icons and an invisible path (e.g. an embedded wire—but that would require a separate icon vision recognition system). The invention could also be implemented with AGVs or robots not following a path 40, but which still follow a pre-programmed course, such as deduced reckoning robots.

FIG. 10 is a schematic plan view of another representative example of an AGV viewable icon 72 which indicated to the AGV and people in the vicinity that the AGV will be yielding to pedestrians at this location. This signal may not actually change the AGV behavior (since it is likely to always yield to pedestrians), but may mainly be for public confidence. The control signal may merely be to have the AGV be more cautious in this location (slower speed, farther obstacle detection range, etc).

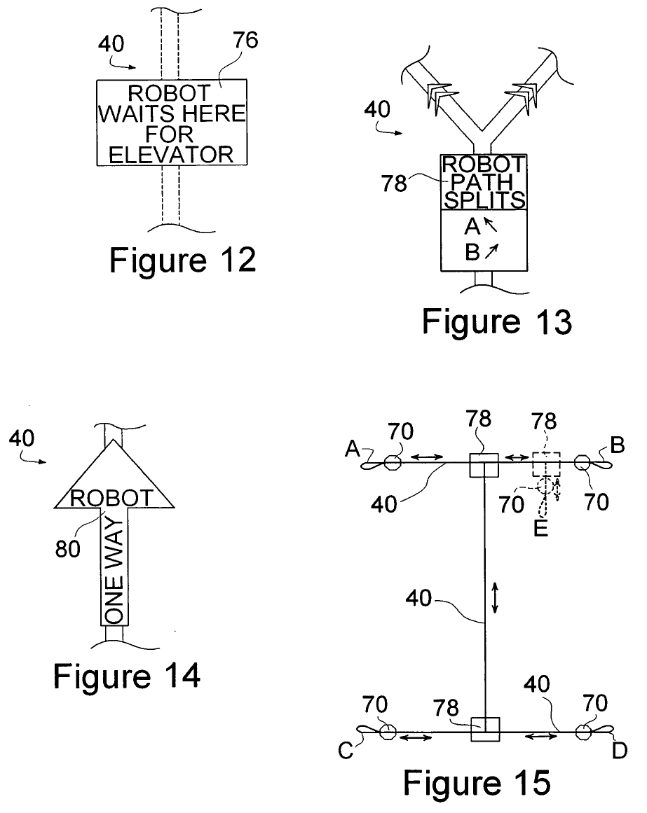

FIG. 11 is a schematic plan view of another representative example of an AGV viewable icon 74 which indicated to the AGV and people in the vicinity a general running speed of the AGV at this section of the path. FIG. 12 is a schematic plan view of another representative example of an AGV viewable icon 76 associated with elevator control. The icon 76 conveys to the AGV and those people around the area where precisely the AGV will wait for the elevator. This may further assist in having people stay out of the way of the AGV and keep from placing carts and the like in undesirable locations for the operation of the AGV. FIGS. 13 and 14 are schematic plan views of other representative examples of AGV viewable icons 78 and 80 for controlling AGV behavior according to the present invention. The icon 78 identifies where a split in the path occurs, which may be useful to convey to people around the area, particularly where one of the paths is traveled relatively infrequently. In other words, workers will not be concerned if the AGV veers off to the left at icon 78 even if it normally takes the right hand path and they will be less likely to obstruct either path. The instructions to the AGV at icon 78 are also important for the reactive system of the present invention. For example, if the AGV is traveling to location B along the path, it need not know how to get to B (other than following the path 40), except that when it gets to icon 78 in FIG. 13 it will know or be told to veer to the right. Further after it passes this icon (on the right path) it will still not have a plan on how to get to B other than following the path (together with following the instructions of other icons as they appear). An icon identifying B will eventually tell the AGV when the designated location has been reached. The icon 80 clearly conveys to the AGV and the patrons in the area a single direction of flow for this portion of the travel path.

The types and number of icons that are possible is effectively limitless. The key to this aspect of the present invention is that visually viewable icons convey control signals to the AGV for AGV routing. Another important aspect is that the icons be readable and visible to humans, to convey expected AGV operation thereto to increase AGV performance and acceptance in the field.

As noted above, FIG. 15 is a schematic plan view of a representative example of an AGV guide path 40 for one floor for the reactive AGV system according to the present invention. This guide path 40 shows a floor path with four distinct locations A, B, C and D (each with an illustrated icon 70 which will preferably identify to the AGV which stop the vehicle is at). Other icons, such as split designations 78 can be used to make the AGV routing more efficient and more appropriate for the setting, as well as to convey intended operation of the vehicle to those in the vicinity. The AGV should have a default rule to follow in case of a split in the guide path 40, which the AGV will resort to if there is no other instruction. For example, the AGV could be instructed to always follow the path the farthest to the right (AKA the right hand rule), unless icons instruct otherwise (e.g. they note the destination is to the left). Preferably the guide path 40 is designed such that the default operation will cover the entire guide path, eventually. With this construction the AGV routing icons 78 will be useful for increasing the efficiency of the routing but not needed for the AGV to eventually get to a designated location (without the instructions 78 the AGV would simply take longer to get to some designated locations depending on the starting point). FIG. 15 demonstrates how easy it is to subsequently modify the guide path 40 after installation. The modifications to the guide path 40 are shown in phantom. After implementation the user adds another branch with stop E to the guide path 40. Icons 78 can be easily added to increase the efficiency of routing the AGV to the new stop E. The subsequent modifications to the system are essential trivial and easily implemented.

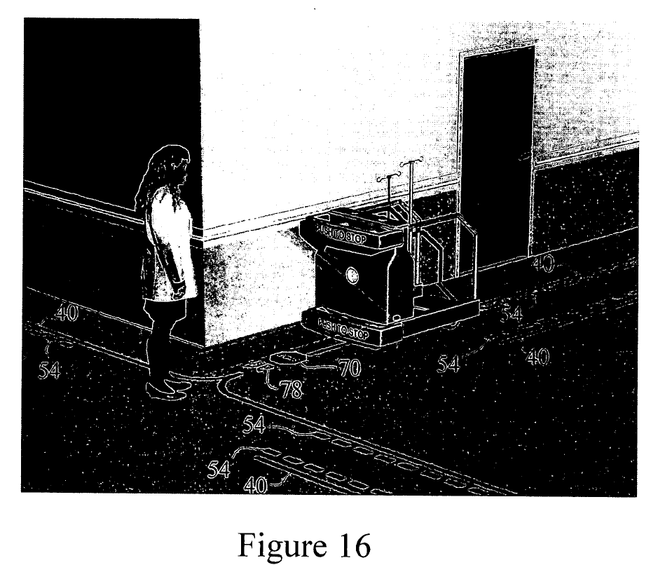

FIG. 16 is a schematic plan view of one representative example of an AGV using a reactive vision guiding system according to the present invention, including guide path 40 for the reactive AGV system according to the present invention. This guide path 40 shows a diverging floor path at a hallway intersection with two distinct locations A, B, each with an illustrated icon 78 making the AGV routing more efficient and more appropriate for the setting. The stop icon 70 and the guide path 40 also convey intended operation of the vehicle to those in the vicinity. FIG. 16 is intended to demonstrate how the visible guide path and icons of the present invention can be used to easily convey to the AGV, and to those in the vicinity thereof, the expected operation thereof. Icons 78 can be easily added to increase the efficiency of routing the AGV. Note that the illustrated set up has “passing zones” designated along the main hallways in FIG. 16. In these passing zones, the AGV can move to the passing lane in response to an open door blocking the designated path in a purely reactive fashion. The guide path 40 indicates to the AGV when it is in a passing zone and which side the passing path is located. Other obstacles to pass include stopped or even oncoming AGVs, whereby the passing zones act as side tracks of a rail line. Further note in the figures that a person is standing in front of the AGV and may be sensed by onboard sensors (proximity or sonar sensors). The AGV may have rules to stop when such obstacles are detected, which is in addition to the information conveyed to the AGV by the guide path 40 and associated icons.

It will be apparent to those of ordinary skill in the art that various modification of the present invention can be made without departing from the spirit and scope of the present invention. The above representations of the present invention are intended to be illustrative of the present invention and not restrictive thereof.

What is claimed is:

1. An automated guided vehicle with a vision guidance system comprising:
A body;
A plurality of surface engaging wheels supporting the body;
A vision guidance camera system mounted to the body at a position beneath the body.

2. The automated guided vehicle with a vision guidance system according to claim 1 wherein the vision guidance camera system is positioned between a pair of the surface engaging wheels.

3. The automated guided vehicle with a vision guidance system according to claim 2 wherein the pair of wheels between which the vision guidance system is mounted are driven wheels for the automated guided vehicle.

4. The automated guided vehicle with a vision guidance system according to claim 3 wherein the vision guidance camera system further includes at least one controlled lighting source mounted between the driven wheels beneath the body.

5. The automated guided vehicle with a vision guidance system according to claim 1 wherein the vision guidance system is configured to receive routing and operational instructions from the perceived physical characteristics of the visible guide path, in addition to the direction of the path.

6. The automated guided vehicle with a vision guidance system according to claim 5 wherein the operational and routing instructions received from the physical parameters of the guide path include the speed of the vehicle.

7. An automated guided vehicle system with vision guidance comprising:
An automated guided vehicle body;
A plurality of surface engaging wheels supporting the body;
A vision guidance system mounted to the body; and
A guide path viewable by the vision guidance system, wherein physical characteristics of the visible guide path convey both the direction of the path and additional operational and routing instructions to the automated guided vehicle.

8. The automated guided vehicle system with vision guidance according to claim 7 wherein the physical characteristics of the guide path used to convey the additional operational and routing instructions to the automated guided vehicle include at least one of, line width of the guide path, color of the guide path; a secondary visible control line, and icons.

9. The automated guided vehicle system with vision guidance according to claim 7 wherein the physical characteristics of the guide path used to convey the additional operational and routing instructions to the automated guided vehicle include icons with human readable portions to convey the intended automated guided vehicle operation to people in the operational vicinity.

10. The automated guided vehicle system with vision guidance according to claim 7 wherein the vision guidance system is a vision guidance camera system mounted to the body at a position beneath the body.

11. The automated guided vehicle system with vision guidance according to claim 10 wherein the pair of wheels between which the vision guidance system is mounted are driven wheels for the automated guided vehicle.

12. The automated guided vehicle system with vision guidance according to claim 11 wherein the vision guidance camera system further includes at least one controlled lighting source mounted between the driven wheels beneath the body.

13. The automated guided vehicle system with vision guidance according to claim 12 wherein the physical characteristics of the guide path used to convey the additional operational and routing instructions to the automated guided vehicle include icons with human readable portions to convey the intended automated guided vehicle operation to people in the operational vicinity.

14. An automated guided vehicle system comprising:
An automated guided vehicle body;
A plurality of surface engaging wheels supporting the body;
A guidance system mounted to the body for following a viewable guide path or for following a pre-programmed path; and
At least one human viewable icon along the guide or pre-programmed path to convey the intended automated guided vehicle operation to people in the operational vicinity.

15. The automated guided vehicle system of claim 14 wherein the human viewable icon conveys at least one of yielding of the automated guided vehicle, stopping of the automated guided vehicle, waiting position for the automated guided vehicle, direction of travel of the automated guided vehicle, loading position for the automated guided vehicle, and path split location for the automated guided vehicle.

16. The automated guided vehicle system of claim 14 wherein the human readable icons are viewable by the guidance system of the automated guided vehicle and convey operational and routing instructions to the automated guided vehicle.

17. The automated guided vehicle system of claim 14 further including a guide path visible by the guidance system.

18. The automated guided vehicle system of claim 14 wherein the vision guidance system is a vision guidance camera system mounted to the body at a position beneath the body.

19. The automated guided vehicle system according to claim 18 wherein the vision guidance camera system is mounted between a pair of wheels and wherein the pair of wheels between which the vision guidance system is mounted are driven wheels for the automated guided vehicle.

20. The automated guided vehicle system according to claim 19 wherein the vision guidance camera system further includes at least one controlled lighting source mounted between the driven wheels beneath the body.
